(19) United States
(12) Patent Application Publication
(10) Pub. No.: US 2010/0014100 A1
(43) Pub. Date: Jan. 21, 2010

(54) APPARATUS FOR SENSING OPTICAL SIGNALS AND APPARATUS FOR REMOTE- CONTROLLING USING OPTICAL SIGNALS

(75) Inventors: Min-Yang YANG, Daejeon (KR); Kang-Min JEON, Daejeon (KR); Hong-Seok YOUN, Chungcheongbuk-do (KR); Seong-Beom KIM, Daejeon (KR)

Correspondence Address: GLOBAL IP COUNSELORS, LLP, 1233 20TH STREET, NW, SUITE 700, WASHINGTON, DC, 20036-2680, US

(73) Assignee: KOREA ADVANCED INSTITUTE OF SCIENCE AND TECHNOLOGY, Daejeon (KR)

(21) Appl. No.: 12/505,174

(22) Filed: Jul. 17, 2009

(30) Foreign Application Priority Data
Jul. 21, 2008 (KR) 10-2008-0070527
May 22, 2009 (KR) 10-2009-0044878

(51) Int. Cl. G01B 11/14

(52) U.S. Cl. 356/614; 977/742

(57) ABSTRACT

There are provided an apparatus for sensing optical signals and a system for remote-controlling using optical signals. An apparatus for sensing optical signals comprises a photoactive layer including an organic semiconductor material, the photoactive layer in which electrons and holes are produced by an incident light; a first conductive pattern formed on one of upper and lower sides of the photoactive layer in a first direction parallel with the surface of the photoactive layer, the first conductive pattern to which the electrons produced in the photoactive layer are moved; a second conductive pattern formed on the other of upper and lower sides of the photoactive layer in a second direction parallel with the surface of the photoactive layer, the second conductive pattern to which the holes produced in the photoactive layer are moved; and an optical position detecting unit for detecting coordinate values of a point at which the incident light is incident onto the photoactive layer using the electrons and holes respectively moved to the first conductive pattern and the second conductive pattern.

### BACKGROUND OF INVENTION

1. Field of Invention

The present invention relates to an apparatus for sensing optical signals and an apparatus for remote-controlling using optical signals.

2. Description of the Related Art

In general, input devices such as keyboards, mice or conventional buttons have been used when users use electronic products such as computers, televisions and mobile phones, etc. Specially, the mouse can be used at a relatively long distance and has the variety of information inputs. However, since the mouse needs to be contacted with a bottom surface, degree of freedom is relatively low. Therefore, in order to improve degrees of freedom and convenience, touch screens or remote controllers have been introduced.

In the touch screens, signals are inputted through a user's physical contact with an object using a finger or pen. Here, the object may be expressed on a monitor as an icon, picture or image. Touching, i.e., physical contact with a screen is usually performed by using a finger, or by using a pen and by using an appropriate stylus or pointing device to prevent stains caused by contamination of the screen. Accordingly, inputting with the touch screen can be implemented more intuitive and faster than inputting with a mouse or a keyboard. However, since a physical impact due to the direct contact may be applied to the screen and input devices, the durability of the screen and input devices needs to be reinforced. Since the inputting with the screen and input devices can be performed by only direct contacting, the implementing inputs at a long distance is impossible.

A remote controller is a device that controls an electronic apparatus such as a display apparatus at a long distance. The remote controller has an advantage that it is capable of implementing inputs at a long distance without pressing buttons of the electronic apparatus. However, since only the buttons of the remote controller can be selected and only the functions of the buttons can be performed, selecting various objects expressed by an icon, a picture or an image on the screen is impossible and performing various functions corresponding to the objects is impossible. Accordingly, the remote controller has problems that degree of freedom is low and the amount of information inputted is limited and inputting various information is impossible.

Therefore, it is required to develop a new input device that solves such problems caused when an electronic apparatus is controlled at a long distance and is combined with advantages of the touch screen and the remote controller.

### SUMMARY OF THE INVENTION

The present invention is conceived to solve the aforementioned problems. Accordingly, the present invention provides an apparatus for sensing optical signals and an apparatus for remote-controlling using optical signals, whose utility is improved by including an organic semiconductor material in a photoactive layer and being manufactured as a flexible product of thin film.

The present invention also provides an apparatus for sensing optical signals and a system for remote-controlling using optical signals, whose manufacturing cost can be reduced by forming entirely the photoactive layer between the first conductive pattern and the second conductive pattern and simplifying the manufacturing process of the product.

The present invention also provides an apparatus for sensing optical signals and a system for remote-controlling using optical signals, which can sense accurately the position at which a optical signal is incident by forming only at intersection areas of the first conductive pattern and the second conductive pattern.

The present invention also provides an apparatus for sensing optical signals and a system for remote-controlling using optical signals, whose transparency can be improved and from which signal outputs can be stably obtained by forming a first conductive pattern as a cathode pattern including indium tin oxide (ITO) and a second conductive pattern as an anode pattern including poly(3,4-ethylenedioxythiophene)poly(styrenesulfonate) (PEDOT:PSS).

The present invention also provides an apparatus for sensing optical signals and a system for remote-controlling using optical signals, whose utility as a transparent electrode can be improved by applying PEDOT:PSS as a conductive polymer to a second conductive pattern and controlling easily electric conductivity, adhesion, fluidity and the like through a variety of additives, and which can be manufactured by using various methods including spin coating, spray coating, roll-to-roll printing, ink jet printing and the like.

The present invention also provides an apparatus for sensing optical signals and a system for remote-controlling using optical signals, which can improve the photovoltaic effect by including any one of [6,6]-phenyl-C61-butyric acid methyl ester (PCBM), trinitrofluorenone (TNF) and TiOx, which are materials having high electron affinity and excellent solubility for an organic solvent as a donor material, and whose efficiency can be improved and whose manufacture can be easily performed by manufacturing the product through solution process and positioning the photoactive layer including the materials in a desired region.

The present invention also provides an apparatus for sensing optical signals and a system for remote-controlling using optical signals, which can sense a two-dimensional movement or a position of an optical signal and sense various signals using a change in intensity of the optical signal.

An apparatus for sensing optical signals related to claim 1 comprises: a photoactive layer including an organic semiconductor material, the photoactive layer in which electrons and holes are produced by an incident light; a first conductive pattern formed on one of upper and lower sides of the photoactive layer in a first direction parallel with the surface of the photoactive layer, the first conductive pattern to which the electrons produced in the photoactive layer are moved; a second conductive pattern formed on the other of upper and lower sides of the photoactive layer in a second direction parallel with the surface of the photoactive layer, the second conductive pattern to which the holes produced in the photoactive layer are moved; and an optical position detecting unit for detecting coordinate values of a point at which the incident light is incident onto the photoactive layer using the electrons and holes respectively moved to the first conductive pattern and the second conductive pattern.

Consequently, according to the apparatus for sensing optical signals related to claim 1, since electrons and holes are separated by the photovoltaic effect of an organic semiconductor material included in the photoactive layer when the incident light is incident onto the photoactive layer, and the electrons and the holes are moved to the first conductive pattern and the second conductive pattern formed on the upper and lower sides of the photoactive layer respectively, a current flows through the first conductive pattern and the second conductive pattern. Accordingly, the coordinate values of a point at which the incident light is incident onto the photoactive layer can be detected by the optical position detecting unit. Further, the apparatus for sensing optical signals can be manufactured not only in a solid form but also in a flexible form. Furthermore, since the photoactive layer is entirely formed between the first conductive pattern and the second conductive pattern, the manufacturing process of the apparatus for sensing optical signals can be simplified, and therefore, its manufacturing cost can be reduced.

An apparatus for sensing optical signals related to claim 2 is the apparatus for sensing optical signals according to claim 1, wherein the first conductive pattern and the second conductive pattern include any one of indium tin oxide (ITO), carbon nano-tube (CNT), aluminum-doped zinc oxide (AZO) and zinc oxide (ZnO). The first conductive pattern and the second conductive pattern serve as transparent electrodes.

Consequently, according to the apparatus for sensing optical signals related to claim 2, since the first conductive pattern and the second conductive pattern are formed as transparent electrodes including any one of ITO, CNT, AZO and ZnO, the incident light which is incident onto the transparent electrode can be well transmitted.

An apparatus for sensing optical signals related to claim 3 is the apparatus for sensing optical signals according to claim 1, wherein: the first conductive pattern may include ITO; the second conductive pattern may include poly(3,4-ethylenedioxythiophene)poly(styrenesulfonate) (PEDOT:PSS); and the first conductive pattern and the second conductive pattern may serve as transparent electrodes.

Consequently, according to the apparatus for sensing optical signals related to claim 3, since the first conductive pattern is formed as a cathode pattern including ITO, and the second conductive pattern is formed as an anode pattern including PEDOT:PSS, the transparency can be improved, and stable signal outputs can be obtained. Further, according to the apparatus for sensing optical signals, since PEDOT:PSS as a conductive polymer is applied to the second conductive pattern, its electric conductivity, adhesion, fluidity and the like can be easily controlled through a variety of additives, and therefore, its utility as a transparent electrode can be improved, and the second conductive pattern can be manufactured by various methods including spin coating, spray coating, roll-to-roll printing, ink jet printing and the like.

An apparatus for sensing optical signals related to claim 4 is the apparatus for sensing optical signals according to claim 1, wherein: the first conductive pattern is an aluminum (Al) electrode; and the second conductive pattern includes any one of ITO, CNT, AZO, and ZnO, and serves as transparent electrodes.

Consequently, according to the apparatus for sensing optical signals related to claim 4, since the first conductive pattern is formed as an Al electrode and the second conductive pattern is formed as a transparent electrode, the efficiency of the apparatus for sensing optical signals can be improved through Al having a work function suitable for accepting electrons.

An apparatus for sensing optical signals related to claim 5 is the apparatus for sensing optical signals according to claim 1, wherein the optical position detecting unit comprises: a converter for converting respectively positions at which currents flowing in the first direction and the second direction are generated into X and Y coordinate values; and a detector for detecting the X coordinate value and Y coordinate value.

Consequently, according to the apparatus for sensing optical signals related to claim 5, since currents flowing into the first conductive pattern and the second conductive pattern are respectively converted into X coordinate value and Y coordinate value by the optical position detecting unit, an incident position of the incident light can be detected.

An apparatus for sensing optical signals related to claim 6 is the apparatus for sensing optical signals according to claim 1, wherein: the photoactive layer senses a change in intensity of the incident light; and the optical position detecting unit further comprises a converter for converting the change in intensity of the incident light into a Z coordinate value, and a detector for detecting the Z coordinate value.

Consequently, according to the apparatus for sensing optical signals related to claim 6, since a change in intensity of the incident light is detected and the change in intensity of the incident light is converted into a Z coordinate value, various information of the incident light can be obtained.

An apparatus for sensing optical signals related to claim 7 is the apparatus for sensing optical signals according to claim 1, wherein the first direction and the second direction are perpendicular to each other.

Consequently, according to the apparatus for sensing optical signals related to claim 7, since the first direction of the first conductive pattern and the second direction of the second conductive pattern are formed perpendicular to each other, an incident position of the incident light can be precisely detected.

An apparatus for sensing optical signals related to claim 8 is the apparatus for sensing optical signals according to claim 1, wherein the organic semiconductor material includes any one of poly(N-vinyl carbazole) (PVCz), 2,6-(4,4-bis(2-ethylhexyl)-4H-cyclopenta[2,1-b;3,4-b′]-dithiophene)-alt-4,7-(2,1,3-benzothiadiazole) (PCPDTBT), poly((2,7-(9,9-dioctyl)-fluorene)-alt-5,5-(4′,7′-di-2-thienyl-2′,1′,3′-benzothiadiazole) (PFDTBT), poly(5,7-di-2-thienyl-2,3-bis(3,5-di(2-ethylhexyloxy)phenyl)-thieno[3,4-b]pyrazine (PTBEHT), poly(3-hexylthiophene) (P3HT) and poly[2-methoxy-5(3′,7′-dimethyloctyloxy)-1,4-phenylene vinylene] (MDMO-PPV).

Consequently, according to the apparatus for sensing optical signals related to claim 8, since the organic semiconductor material is included in the photoactive layer, the position at which the incident light is incident can be detected, and the apparatus for sensing optical signals can be manufactured in a flexible form.

An apparatus for sensing optical signals related to claim 9 is the apparatus for sensing optical signals according to claim 8, wherein: the organic semiconductor material serves as a donor or acceptor; the donor includes any one of PCPDTBT, PFDTBT, PTBEHT, P3HT and MDMO-PPV; and the acceptor includes any one of [6,6]-phenyl-C61-butyric acid methyl ester (PCBM), trinitrofluorenone (TNF) and TiOx.

Consequently, according to the apparatus for sensing optical signals related to claim 9, since the donor material includes any one of PCBM, TNF and TiOx, which are materials having high electron affinity and excellent solubility for an organic solvent, the photovoltaic effect can be improved. Further, according to the apparatus for sensing optical signals, solution process can be used when manufacturing the apparatus for sensing optical signals, and therefore, the photoactive layer including the materials can be positioned in a desired region. Accordingly, the apparatus for sensing optical signals can be easily manufactured and its efficiency can be improved.

An apparatus for sensing optical signals related to claim 10 is the apparatus for sensing optical signals according to claim 1 further comprises: an electron transfer layer formed between the photoactive layer and the first conductive pattern to help the electrons move; and a hole transfer layer formed between the photoactive layer and the second conductive pattern to help the holes move, wherein the electron transfer layer includes any one of TiOx and PCBM, and the hole transfer layer includes PEDOT:PSS.

Consequently, according to the apparatus for sensing optical signals related to claim 10, since the electron transfer layer includes any one of TiOx and PCBM and the hole transfer layer includes PEDOT:PSS, electrons and holes separated in the photoactive layer can be easily moved to the first conductive pattern and the second conductive pattern.

An apparatus for sensing optical signals related to claim 11 comprises: a photoactive layer including an organic semiconductor material, the photoactive layer in which electrons and holes are produced by an incident light; a first conductive pattern formed on one of upper and lower sides of the photoactive layer in a first direction parallel with the surface of the photoactive layer, the first conductive pattern to which the electrons produced in the photoactive layer are moved; a second conductive pattern formed on the other of upper and lower sides of the photoactive layer in a second direction parallel with the surface of the photoactive layer, the second conductive pattern to which the holes produced in the photoactive layer are moved; and an optical position detecting unit for detecting coordinate values of a point at which the incident light is incident using the electrons and holes respectively moved to the first conductive pattern and the second conductive pattern, wherein the photoactive layer are formed only at intersection areas of the first conductive pattern and the second conductive pattern.

Consequently, according to the apparatus for sensing optical signals related to claim 11, since electrons and holes are separated by the photovoltaic effect of an organic semiconductor material included in the photoactive layer when the incident light is incident and the electrons and the holes are moved to the first conductive pattern and the second conductive pattern formed on the upper and lower sides of the photoactive layer, respectively, a current flows through the first conductive pattern and the second conductive pattern. Accordingly, the coordinate values of a point at which the incident light is incident onto the photoactive layer can be detected by the optical position detecting unit. Further, the apparatus for sensing optical signals can be manufactured not only in a solid form but also in a flexible form. Furthermore, since the photoactive layer is formed at only intersection areas of the first conductive pattern and the second conductive pattern, the position at which the optical signal is incident can be accurately sensed.

An apparatus for remote-controlling using optical signals related to claim 12 comprises: an optical signal generating unit for generating an optical signal through an operation of a user; a display unit for receiving the optical signal and displaying an image or menu selected by the optical signal and a content corresponding to the image or the menu; an optical sensor unit for sensing the optical signal and detecting coordinate values of a point at which the optical signal is incident onto the display unit; and a control unit for transmitting an image or menu corresponding to the coordinate values and a content corresponding to the image and the menu to the display unit, wherein the optical sensor unit is the apparatus for sensing optical signals related claim 1 or claim 11.

Consequently, according to the apparatus for remote-controlling using optical signals related to claim 12, since the optical sensor unit comprises a photoactive layer including an organic semiconductor material and the apparatus comprises the display unit receiving the optical signal and displaying an image or menu selected by the optical signal and a content corresponding to the image or the menu, the apparatus can display an information corresponding to an incident position of the incident optical signal and a change in intensity of the incident optical signal

According to the present invention configured as described above, since an organic semiconductor material is included in a photoactive layer and the apparatus for sensing optical signal is manufactured as a flexible product of thin film, an utility of the product can be improved. Accordingly, the product can be used not only when an electronic product such as a TV or computer is used at a long distance but also when presentation is made at a large-scale seminar, and the like.

According to the present invention, since a photoactive layer is entirely formed between the first conductive pattern and the second conductive pattern and the manufacturing process of the product is simplified, manufacturing cost of the product can be reduced.

According to the present invention, since a photoactive layer is formed only at intersection areas of the first conductive pattern and the second conductive pattern, the position at which an optical signal is incident can be accurately sensed.

According to the present invention, since the first conductive pattern is formed as a cathode pattern including ITO and the second conductive pattern is formed as an anode pattern including PEDOT:PSS, the transparency of the apparatus can be improved, and signal outputs from the apparatus can be stably obtained.

According to the present invention, since PEDOT:PSS as a conductive polymer is applied to the second conductive pattern, and its electric conductivity, adhesion, fluidity and the like can be easily controlled through a variety of additives, its utility as a transparent electrode can be improved. Since various methods including spin coating, spray coating, roll-to-roll printing, ink jet printing and the like are used, the second conductive pattern can be manufactured.

According to the present invention, since a donor material includes any one of PCBM, TNF and TiOx, which are materials having high electron affinity and excellent solubility for an organic solvent, the photovoltaic effect can be improved and the solution process can be used. In addition, since the product is manufactured through solution process and positioning the photoactive layer including the materials in a desired region, its manufacture can be easily performed.

According to the present invention, a two-dimensional movement or a position of an optical signal and sense various signals can be sensed by using a change in intensity of the optical signal.

The objects, constructions and effects of the present invention are included in the following embodiments and drawings. The advantages, features, and achieving methods of the present invention will be more apparent from the following detailed description in conjunction with embodiments and the accompanying drawings. The same reference numerals are used throughout the drawings to refer to the same or like parts.

### BRIEF DESCRIPTION OF THE DRAWINGS

The above and other features and advantages of the present invention will become more apparent to those of ordinary skill in the art by describing in detail preferred embodiments thereof with reference to the attached drawings, in which:

FIG. 1 is a cross-sectional drawing illustrating the structure of an apparatus for sensing optical signals according to a first embodiment of the present invention;

FIG. 2A is a drawing illustrating a photoactive layer positioned between the first conductive pattern and the second conductive pattern in an apparatus for sensing optical signals according to a first embodiment of the present invention;

FIG. 2B is a drawing illustrating a photoactive layer positioned at only intersection areas of the first conductive pattern and the second conductive pattern in an apparatus for sensing optical signals according to a second embodiment of the present invention;

FIG. 3 is a cross-sectional drawing illustrating structure of an apparatus for sensing optical signals in which an electron transfer layer and a hole transfer layer are added to upper and lower sides of the photoactive layer of the apparatus for sensing optical signals shown in FIG. 1;

FIG. 4 is a block diagram illustrating the structure of an optical position detecting unit in an apparatus for sensing optical signals according to an embodiment of the present invention;

FIG. 5 is a cross-sectional drawing illustrating a display apparatus including an apparatus for sensing optical signals according to a third embodiment of the present invention; and

FIG. 6 is a block diagram illustrating an apparatus for remote-controlling using optical signals according to a fourth embodiment of the present invention.

### DETAILED DESCRIPTION OF THE INVENTION

Hereinafter, an apparatus for sensing optical signals and a system for remote-controlling using optical signals according to an exemplary embodiment of the present invention will be described in detail with reference to the accompanying drawings. However, the present invention is not limited to the embodiments but may be implemented into different forms. These embodiments are provided only for illustrative purposes and for full understanding of the scope of the present invention by those skilled in the art.

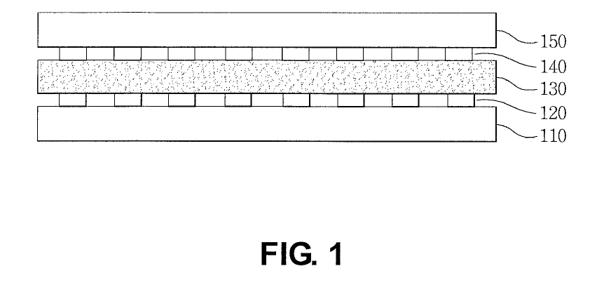

FIG. 1 is a cross-sectional drawing illustrating the structure of an apparatus for sensing optical signals according to a first embodiment of the present invention.

As shown in FIG. 1, the apparatus for sensing optical signals according to the first embodiment of the present invention comprises: a photoactive layer 130 including an organic semiconductor material, in which electrons and holes are produced by an incident light; a first conductive pattern 140 formed on the upper sides of the photoactive layer 130 in a first direction parallel with the surface of the photoactive layer 130, to which the electrons produced in the photoactive layer 130 are moved; a second conductive pattern 120 formed on the lower sides of the photoactive layer 130 in a second direction parallel with the surface of the photoactive layer 130, to which the holes produced in the photoactive layer 130 are moved; and an optical position detecting unit (not shown) for detecting coordinate values of a point at which the incident light is incident using the electrons and holes moved respectively to the first conductive pattern 140 and the second conductive pattern 120. A first transparent substrate 150 is formed on the first conductive pattern 140, and a second transparent substrate 110 is formed beneath the second conductive pattern 120.

The photoactive layer 130 includes an organic semiconductor material and senses the incident light using the photovoltaic effect of the organic semiconductor material. That is, if the incident light is applied to the photoactive layer 130, electricity is generated by the photovoltaic effect. That is, if the incident light is applied to the photoactive layer 130, excitons are generated in the photoactive layer 130 and the excitons are separated into electrons and holes. The electrons and holes are respectively moved to the first conductive pattern 140 and the second conductive pattern 120, and the electricity is generated.

The first conductive pattern 140 determines the X coordinate value of a point at which the incident light is incident onto the photoactive layer 130 by detecting current flowing in the first direction.

The second conductive pattern 120 determines the Y coordinate value of a point at which the incident light is incident onto the photoactive layer 130 by detecting current flowing in the second direction. The first direction is substantially perpendicular to the second direction so that the X axis and Y axis are defined on a plane of the photoactive layer 130.

In one embodiment, the first conductive pattern 140 and the second conductive pattern 120 include indium-tin oxide (ITO) to serve as transparent electrodes in order to utilize characteristics of its high transmittance, high conductivity, high productivity and the like. Alternatively, the first conductive pattern 140 and the second conductive pattern 120 includes any one of carbon nano-tube (CNT), aluminum-doped zinc oxide (AZO), zinc oxide (ZnO) and the like.

In another embodiment, the first conductive pattern 140 is formed as an aluminum (Al) electrode layer including Al, and the second conductive pattern 120 includes any one of ITO, CNT, AZO and ZnO. In the present invention, since the first conductive pattern 140 is formed as the aluminum (Al) electrode layer, efficiency of the photoactive layer can be improved. This is because Al has a work function more suitable for accepting electrons than the work function of a transparent electrode.

In still another embodiment, since the first conductive pattern 140 includes ITO, and the second conductive pattern 120 includes poly(3,4-ethylenedioxythiophene)poly(styrenesulfonate) (PEDOT:PSS), the first conductive pattern 140 and the second conductive pattern 120 serve as transparent electrodes. In the present invention, in order to secure the transparency of the first conductive pattern 140 and the second conductive pattern 120, the first conductive pattern 140 includes ITO (−4.8 eV) having a low work function so as to be used as a cathode, and the second conductive pattern 120 includes PEDOT:PSS (−5.0 eV) having a work function lower than the work function of ITO so as to be used as an anode. Here, the PEDOT:PSS is a conductive polymer. When PEDOT:PSS being coated as a thin layer on the second conductive pattern 120, the second conductive pattern 120 can be manufactured to be more transparent than the conventional electrode formed of a material such as CNT, and its electric conductivity, adhesion, fluidity and the like can be easily controlled through a variety of additives. For example, dimethyl sulfoxide (DMSO) as an additive may be added to the PEDOT:PSS in order to improve the electric conductivity. Accordingly, since the material to which the electric conductivity is improved is added, stable signal outputs of the apparatus for sensing the optical signals can be obtained. In addition, in order to have good adhesion with a substrate, isopropanol (IPA) as an additive may be added to the PEDOT:PSS so that the PEDOT:PSS serves as a transparent electrode. Accordingly, transparency of an apparatus for sensing optical signals can be secured. Further, the second conductive pattern 120 can be easily manufactured by various methods including spin coating, spray coating, roll-to-roll printing, ink jet printing and the like.

The first transparent substrate 150 and the second transparent substrates 110 refer to transparent substrates formed of glass or transparent plastic.

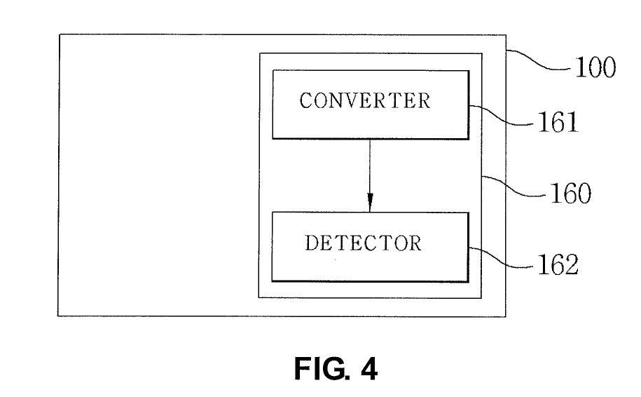

Although not shown in FIG. 1, the apparatus for sensing optical signals is connected to an optical position detecting unit to detect coordinate values of a point at which the incident light is incident by using the electrons and holes moved respectively to the first conductive pattern 140 and the second conductive pattern 120. To calculate the coordinate values of the point at which the incident light is incident, the optical position detecting unit comprises a converter (not shown) for converting position at which current flowing in the first direction is generated and position at which current flowing the second direction is generated into X coordinate value and Y coordinate value respectively; and a detector (not shown) for detecting the X coordinate value and Y coordinate value. The optical position detecting unit will be described in detail in FIG. 4.

When another signal except a two-dimensional signal with the X direction and the Y direction is applied to the apparatus for sensing optical signals, the apparatus for sensing optical signals can detect the another signal using the intensity or the pulse of the incident light. That is, the apparatus for sensing optical signals can detect three-dimensional coordinate values by converting the another signal into a Z coordinate value, using a method of applying a strong optical signal or flickering optical signal to a specific icon displayed on a screen of a display apparatus or a method of applying an optical signal moved in a direction vertical to the screen, or the like.

Accordingly, in the apparatus for sensing optical signals according to the first embodiment of the present invention, electrons and holes are separated by an organic semiconductor material when an optical signal is incident onto the photoactive layer 130. At this time, since the electrons and the holes are moved to the first conductive pattern 140 and the second conductive pattern 120, respectively, current flows through the first conductive pattern 140 and the second conductive pattern 120. Here, the current flowing through the first conductive pattern 140 and the second conductive pattern 120 is detected by an optical position detecting unit installed at the inside or outside of the apparatus for sensing optical signals.

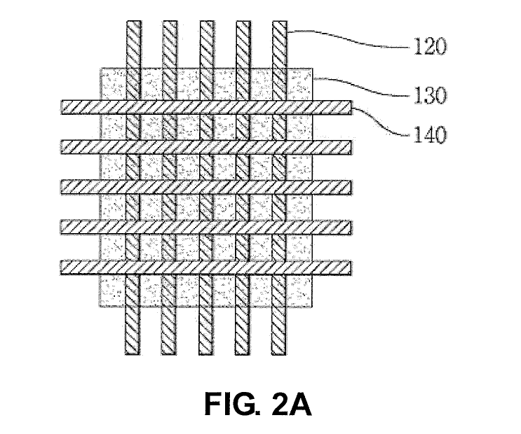

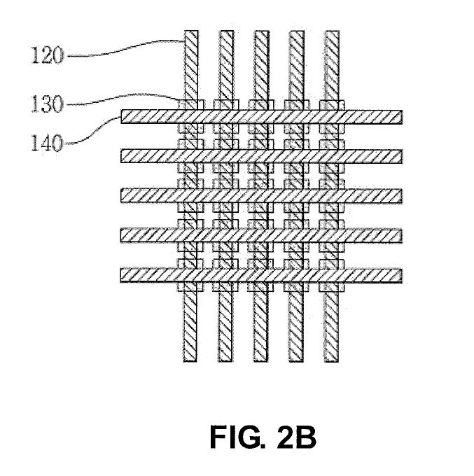

Hereinafter, a method for applying and detecting three-dimensional signals will be described in detail with reference to FIG. 2A and FIG. 2B.

FIG. 2A is a drawing illustrating a photoactive layer positioned between the first conductive pattern and the second conductive pattern in an apparatus for sensing optical signals according to a first embodiment of the present invention, and FIG. 2B is a drawing illustrating a photoactive layer positioned at only intersection areas of the first conductive pattern and the second conductive pattern in an apparatus for sensing optical signals according to a second embodiment of the present invention.

As shown in FIG. 2A, the conductive pattern in the apparatus for sensing optical signals according to the first embodiment of the present invention comprises the first conductive pattern 140 formed on a photoactive layer 130 in a first direction parallel with the surface of the photoactive layer 130, to which the electrons produced in the photoactive layer 130 are moved; and the second conductive pattern 120 formed beneath the photoactive layer 130 in a second direction parallel with the surface of the photoactive layer 130, to which the holes produced in the photoactive layer 130 are moved.

The photoactive layer 130 is entirely formed between the first conductive pattern 140 and the second conductive pattern 120.

When the incident light is incident onto the photoactive layer 130, electricity is generated by the photovoltaic effect of an organic semiconductor material. That is, since electrons and holes are produced in the photoactive layer 130 by the photovoltaic effect and moved respectively to the first conductive pattern 140 and the second conductive pattern 120, electricity is generated. Hereinafter, the photovoltaic effect will be described. When the incident light is incident onto the photoactive layer 130 including an organic semiconductor material, excitons are formed by the organic semiconductor material. The exciton refers to a pair of an electron and a hole. If an exciton meets the interface between a donor and an acceptor while diffusing in any direction, the exciton is separated into the electron and the hole. That is, since the electron is moved to the acceptor having a high electron affinity and the hole remains at the donor, the electron and the hole are separated to have respective charge states. The electron and the hole are moved and collected to respective electrodes due to the internal electric field formed by the difference between the work functions of both electrodes and due to the difference between the concentrations of accumulated charges. Finally, current flows through an external circuit. This phenomenon is defined as the photovoltaic effect in organic semiconductor.

In the present invention, when optical signals are incident onto the photoactive layer 130, electrons and holes are separated by the organic semiconductor material. At this time, since the electrons and the holes are respectively moved to the first conductive pattern 140 and the second conductive pattern 120, current flows through the first conductive pattern 140 and the second conductive pattern 120. Here, the current flowing through the first conductive pattern 140 and the second conductive pattern 120 is detected by an optical position detecting unit installed at the inside or outside of the apparatus for sensing optical signals.

The first conductive pattern 140 determines the X coordinate value of a point at which the incident light is incident onto the photoactive layer 130 by detecting current flowing in the first direction. The second conductive pattern 120 determines the Y coordinate value of a point at which the incident light is incident onto the photoactive layer 130 by detecting current flowing in the second direction.

The photoactive layer 130 has a property in which an output voltage is changed according to the intensity of light. That is, If the intensity or the pulse of the incident light is changed by an optical signal generating unit (not shown) positioned at a long distance, the output voltage of the photoactive layer 130 is changed accordingly. At this time, three-dimensional coordinate values on points of the optical signal generated by the optical signal generating unit can be measured through the output voltage changed in the photoactive layer 130. Accordingly, a three-dimensional signal can be sensed by a third signal such as the intensity or the pulse of the incident light which is incident onto the photoactive layer 130, using a method of applying a strong optical signal or flickering optical signal to a specific icon displayed on a screen of a display apparatus or a method of applying an optical signal moved in a direction vertical to the screen, or the like.

As shown in FIG. 2B, the conductive pattern in the apparatus for sensing optical signals according to the second embodiment of the present invention has a structure in which a photoactive layer 130 is positioned at only intersection areas of the first conductive pattern 140 and the second conductive pattern 120 formed like the first conductive pattern and the second conductive pattern of FIG. 2A.

Unlike the photoactive layer 130 of FIG. 2A, since the photoactive layer 130 of FIG. 2B is positioned only at intersection areas of the first and second conductive patterns 140 and 120, the sensitivity and accuracy of incident optical signals can be improved. When the incident light is incident onto the photoactive layer, electrons and holes produced in the photoactive layer 130 are respectively moved to the first conductive pattern 140 and the second conductive pattern 120, and current flows through the first conductive pattern 140 and the second conductive patterns 120. Accordingly, the position of the incident light can be detected by an optical position detecting unit.

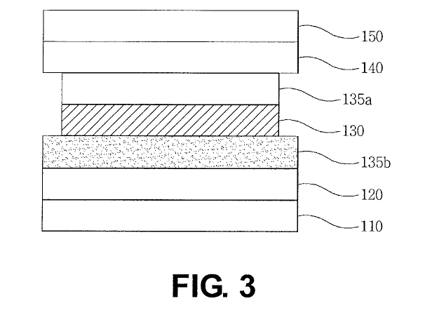

FIG. 3 is a cross-sectional drawing illustrating structure of an apparatus for sensing optical signals in which an electron transfer layer and a hole transfer layer are added to upper and lower sides of the photoactive layer of the apparatus for sensing optical signals shown in FIG. 1.

As shown in FIG. 3, the apparatus for sensing optical signals according to the embodiment of the present invention comprises a second transparent electrode layer 120 formed on a second transparent substrate 110; an optical sensor layer 135b, 130 and 135a formed on the second transparent electrode layer 120; a first transparent electrode layer 140 formed on the optical sensor layer 135b, 130 and 135a; and a first transparent substrate 150 formed on the first transparent electrode layer 140. The first transparent electrode layer 140 and the second transparent electrode layer 120 of FIG. 3 correspond to the first conductive pattern and the second conductive pattern of FIG. 1, respectively. In FIG. 3, the first transparent electrode layer 140 and the second transparent electrode layer 120 are not illustrated as a pattern shape but illustrated as a layered structure.

Meanwhile, the first transparent substrate 150 and the second transparent substrate 110, the first transparent electrode layer 140 and the second transparent electrode layer 120 and the optical sensor layer 135b, 130 and 135a have a substantially transparent structure which transmits the incident light.

In one embodiment, the optical sensor layer 135b, 130 and 135a comprises a photoactive layer 130 including an organic semiconductor material; an electron transfer layer 135a including an inorganic material and formed on the photoactive layer 130 to help the electrons move; and a hole transfer layer 135b including a highly conductive organic material and formed beneath the photoactive layer 130 to help the holes move.

The organic semiconductor material included in the photoactive layer 130 includes any one of poly(N-vinyl carbazole) (PVCz), 2,6-(4,4-bis(2-ethylhexyl)-4H-cyclopenta[2,1-b;3,4-b′]-dithiophene)-alt-4,7-(2,1,3-benzothiadiazole) (PCPDTBT), poly((2,7-(9,9-dioctyl)-fluorene)-alt-5,5-(4′,7′-di-2-thienyl-2′,1′,3′-benzothiadiazole) (PFDTBT), poly(5,7-di-2-thienyl-2,3-bis(3,5-di(2-ethylhexyloxy)phenyl)-thieno[3,4-b]pyrazine (PTBEHT), poly(3-hexylthiophene) (P3HT) and poly[2-methoxy-5(3′,7′-dimethyloctyloxy)-1,4-phenylene vinylene] (MDMO-PPV).

The material included in the electron transfer layer 135b includes any one of TiOx and [6,6]-phenyl-C61-butyric acid methyl ester (PCBM). PEDOT:PSS is used as the organic conductive material included in the hole transfer layer 135b. In the present invention, an optical sensor layer will be described as an example hereinbelow, which comprises a photoactive layer 130 including PVCz, an electron transfer layer 135a including TiOx and a hole transfer layer 135b including PEDOT:PSS.

That is, the hole transfer layer (HTL) 135b including PEDOT:PSS is formed on the second transparent substrate 110. The photoactive layer 130 including PVCz, in which electrons and holes are substantially produced by incident light, is formed on the hole transfer layer 135b. The electron transfer layer (ETL) 135a including TiOx is formed on the photoactive layer 130.

The first transparent electrode layer 140 is formed on the electron transfer layer 135a to form an electrode. Here, the first transparent electrode layer 140 and the second transparent electrode layer 120 serve as electrodes.

In another embodiment, since the first transparent electrode layer 140 is formed as an Al electrode layer including Al, efficiency of the optical sensor layer 135b, 130 and 135a can be improved. This is because the work function of Al is more suitable for accepting electrons than that of ITO. The first transparent electrode layer 140 will be described as an aluminum electrode layer hereinbelow.

Here, a substantial photovoltaic effect occurs in the photoactive layer 130, and the hole transfer layer 135b and the electron transfer layer 135a help the electrons and the holes produced in the photoactive layer 130 move. However, the organic semiconductor material (PVCz), the highly conductive organic material (PEDOT:PSS) and the inorganic material (TiOx) are only examples. It will be apparent that an organic semiconductor material, a highly conductive organic material and an inorganic material, which have effects similar to those of the aforementioned materials, may be used in the apparatus for sensing optical signals according to the embodiment of the present invention.

As described above, it will be appreciated that the transparent apparatus for sensing optical signals including the organic semiconductor material (PVCz), the highly conductive organic material (PEDOT:PSS) and the inorganic material (TiOx), reacts selectively with respect to the incident light having a specific wavelength (e.g., a wavelength of about 405 nm).

Meanwhile, as a modified embodiment of the photoactive layer 130, the organic semiconductor material serves as an electron donor or electron acceptor. The electron donor includes any one of poly(N-vinyl carbazole) (PVCz), 2,6-(4,4-bis(2-ethylhexyl)-4H-cyclopenta[2,1-b;3,4-b′]-dithiophene)-alt-4,7-(2,1,3-benzothiadiazole) (PCPDTBT), poly((2,7-(9,9-dioctyl)-fluorene)-alt-5,5-(4′,7′-di-2-thienyl-2′,1′,3′-benzothiadiazole) (PFDTBT), poly(5,7-di-2-thienyl-2,3-bis(3,5-di(2-ethylhexyloxy)phenyl)-thieno[3,4-b]pyrazine (PTBEHT), poly(3-hexylthiophene) (P3HT) and poly[2-methoxy-5(3′,7′-dimethyloctyloxy)-1,4-phenylene vinylene] (MDMO-PPV). The electron acceptor includes any one of [6,6]-phenyl-C61-butyric acid methyl ester (PCBM), trinitrofluorenone (TNF) and TiOx.

Here, the PCBM used as an acceptor is a C60-based material having excellent electron affinity. In the exciton generated at the donor by the incident light, the electron is attracted by an acceptor material (C60-based material) having excellent electron affinity. The PCBM is a material having excellent solubility for an organic solvent and available for solution process. Accordingly, the photovoltaic effect can be improved using the PCBM as an acceptor material, and the PCBM can be positioned in a desired region. For this reason, the PCBM is a material suitable for the apparatus for sensing optical signals.

FIG. 4 is a block diagram illustrating the structure of an optical position detecting unit in an apparatus for sensing optical signals according to an embodiment of the present invention.

As shown in FIG. 4, the apparatus for sensing optical signals according to the embodiment of the present invention comprises an optical position detecting unit 160 for detecting coordinate values of a position at which the incident light is incident onto an optical sensor layer.

The optical position detecting unit 160 comprises a converter 161 for converting a position at which current flowing in the first direction and a position at which current flowing the second direction are generated into X coordinate value and the Y coordinate value respectively; and a detector 162 for detecting the X coordinate value and the Y coordinate value.

In the optical position detecting unit 160, a change in output voltage of the optical sensor layer, caused by a change in intensity or pulse of the incident light, is converted into a Z coordinate value by the converter 161, and the Z coordinate value is detected by the detector 162.

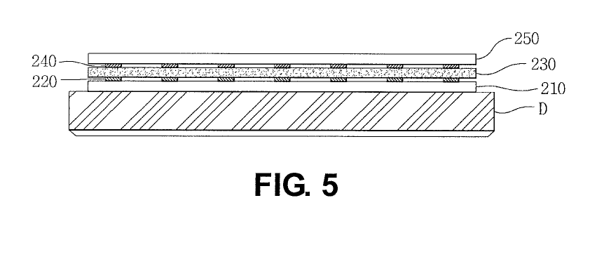

FIG. 5 is a cross-sectional drawing of a display apparatus including an apparatus for sensing optical signals according to a third embodiment of the present invention.

As shown in FIG. 5, the display apparatus including the apparatus for sensing optical signals according to the third embodiment of the present invention has a structure in which an apparatus for sensing optical signals having one of the structures of FIGS. 1 to 4 is attached to a surface of a display apparatus D.

As described above, the apparatus for sensing optical signals, attached to the display apparatus D has a substantially transparent structure which transmits the incident light well.

Accordingly, the display apparatus D can display an image or menu selected by an optical signal or a content corresponding to the image or the menu by receiving the optical signal sensed through the apparatus for sensing optical signals, attached to the display apparatus D.

In the display apparatus including the apparatus for sensing optical signals according to the third embodiment of the present invention, the first conductive pattern 240 and the second conductive pattern 220 serve as transparent electrodes. The transparent electrode of the first conductive pattern 240 includes ITO, and the transparent electrode of the second conductive pattern 220 includes PEDOT:PSS. The apparatus for sensing optical signals, which comprises the first conductive pattern 240 and the second conductive pattern 220, is attached to an upper surface of the display apparatus D or is installed inside of the display apparatus D. Accordingly, the display apparatus D can stably display the image or the menu selected by the optical signal or the content corresponding to the image or the menu by receiving the optical signal sensed through the apparatus for sensing optical signals.

In the display apparatus including the apparatus for sensing optical signals according to the third embodiment of the present invention, an organic semiconductor material serves as a donor or an acceptor. The donor includes any one of PVCz, PCPDTBT, PFDTBT, PTBEHT, P3HT and MDMO-PPV, and the acceptor includes any one of PCBM, TNF and TiOx. The apparatus for sensing optical signals, which includes the organic semiconductor material, is attached on the display apparatus D. Since a material having high electron affinity and excellent solubility for an organic solvent is used as an acceptor, the photovoltaic effect can be improved. Further, since the material is available for solution process, the material can be positioned in a desired region. Accordingly, the display apparatus can display stably.

Hereinafter, an apparatus for remote-controlling using optical signals will be described in detail, in which a display apparatus can be effectively controlled by a user at a long distance, using the display apparatus D including the apparatus for sensing optical signals.

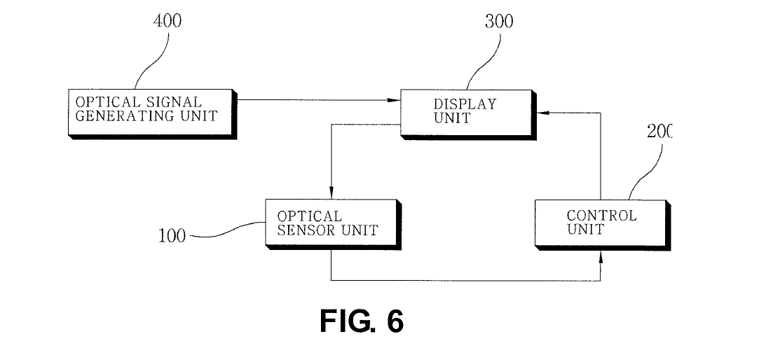

FIG. 6 is a block diagram illustrating an apparatus for remote-controlling using optical signals according to a fourth embodiment of the present invention.

As shown in FIG. 6, the apparatus for remote-controlling using optical signals comprises an optical signal generating unit 400 for generating an optical signal through an operation of a user; a display unit 300 for receiving the optical signal and displaying an image or menu selected by an optical signal or a content corresponding to the image or menu ; an optical sensor unit 100 for sensing the optical signal and detecting coordinate values of a point at which the optical signal is incident onto the display unit 300; and a control unit 200 for transmitting an image or menu corresponding to the coordinate values or the content corresponding to the image or the menu to the display unit 300.

The apparatus for remote-controlling using optical signals further comprises a memory (not shown) for storing the image or the menu selected by the optical signal or the content corresponding to the image or the menu.

The optical signal generating unit 400 is a remote input device operated by a user so as to interact with the display unit 300. For example, the remote input device includes a remote controller or a laser pointer.

The optical signal generating unit 400 comprises an optical signal generator (not shown) for generating optical signals; a switch (not shown) for controlling on/off of optical signals; and a controller (not shown) for controlling the intensity of optical signals.

The optical signal generated from the optical signal generating unit 400 is a point light source such as a laser, and the point light source is incident onto a screen of the display unit 300.

In this case, it is desirable that the optical signal is an optical signal having a specific wavelength which the optical sensor unit 100 reacts selectively. The optical signal transmits into the optical sensor unit 100. Further, it is desirable that the optical signal is implemented as an invisible ray which is not seen by a user. The optical signals generated from the optical signal generating unit 400 are on/off controlled by the switch.

When a point is formed on the screen of the display unit 300 by an optical signal generated from the optical signal generating unit 400, a control signal is generated so that a menu displayed on the screen can be selected by controlling the position of the point. The menu selected by the control signal is executed. The controller allows an optical signal to be inputted in various methods that control the intensity of the optical signal or that flicker the optical signal.

The display unit 300 is used to display images or menus. The display unit 300 receives an optical signal for the menu generated from the optical signal generating unit 400 having an optical generator such as the remote controller or the pointer and provides a submenu or a content corresponding to the submenu. The display unit 300 can be implemented as a cathode ray tube (CRT), a liquid crystal display (LCD), a plasma display panel (PDP) or the like.

At this time, the menu is a concept including not only a content for image setup change of a display apparatus such as an on screen display (OSD) but also a content for environment setup such as time setup. The menu may include all the menus supported from the display apparatus so as to control the display apparatus. Such a menu may be a menu predetermined in the display apparatus or a menu included in an optical signal inputted from an external device.

The optical sensor unit 100 senses an optical signal received through the display unit 300 and calculates coordinate values of a point at which the optical signal is incident onto the display unit 300. The optical sensor unit 100 further comprises an optical sensor layer (see FIG. 3) for sensing an optical signal inputted through the display unit 300 and converting the sensed optical signal into an electric signal to be outputted; and an optical position detecting unit 160 for receiving the electrical signal inputted from the optical sensor layer and calculating coordinate values of a point at which the optical signal is incident onto the display unit 300.

In the optical sensor unit 100, an optical sensor layer is formed between the first conductive pattern and the second conductive pattern formed into a lattice structure, or one optical sensor layer is disposed at each intersection area of the first conductive pattern and the second conductive pattern. Accordingly, the optical signal inputted into each of the areas can be sensed. Since the optical sensor layer has the same structure as that of the optical sensor layer of FIG. 3, its detailed description will be omitted. The optical position detecting unit 160 receives the electric signal generated from the optical sensor unit 100 and outputs the position information at which the optical signal is incident onto the display unit 300 as X, Y and Z coordinate values respectively using the row number of the first conductive pattern, the column number of the second conductive pattern and the intensity of the optical signal.

In the memory (not shown), an image or menu corresponding to the outputted X, Y and Z coordinate values or a content corresponding to the image or menu can be stored. Also, a control or an application program for controlling whole operations of the display apparatus, and the like can be stored.

The control unit 200 determines which image or menu is selected by the optical signal, by using the coordinate values calculated by the optical position detecting unit and the content stored in the memory, and provides the content corresponding to the image or menu to the display unit 300. When submenus exist in the selected image or menu, the control unit 200 provides the corresponding submenus to the display unit 300. When an optical signal for selecting the submenus is inputted, the control unit 200 provides a content corresponding to the submenus to the display unit 300. The display unit 300 displays the content corresponding to the selected image or menu and the content corresponding to the submenus.

As described above, according to the apparatus for sensing optical signals and the apparatus for remote-controlling using optical signals according to an embodiment of the present invention, since an organic semiconductor material is included in a photoactive layer and the apparatus for sensing optical signal is manufactured as a flexible product of thin film, an utility of the product can be improved. Accordingly, the product can be used not only when an electronic product such as a TV or computer is used at a long distance but also when presentation is made at a large-scale seminar, and the like.

According to the present invention, since a photoactive layer is entirely formed between the first conductive pattern and the second conductive pattern and the manufacturing process of the product is simplified, manufacturing cost of the product can be reduced.

According to the present invention, since a photoactive layer is formed only at intersection areas of the first conductive pattern and the second conductive pattern, the position at which an optical signal is incident can be accurately sensed.

According to the present invention, since the first conductive pattern is formed as a cathode pattern including ITO and the second conductive pattern is formed as an anode pattern including PEDOT:PSS, the transparency of the apparatus can be improved, and signal outputs from the apparatus can be stably obtained.

According to the present invention, since PEDOT:PSS as a conductive polymer is applied to the second conductive pattern, and its electric conductivity, adhesion, fluidity and the like can be easily controlled through a variety of additives, its utility as a transparent electrode can be improved. Since various methods including spin coating, spray coating, roll-to-roll printing, ink jet printing and the like are used, the second conductive pattern can be manufactured.

According to the present invention, since a donor material includes any one of PCBM, TNF and TiOx, which are materials having high electron affinity and excellent solubility for an organic solvent, the photovoltaic effect can be improved and the solution process can be used. In addition, since the product is manufactured through solution process and positioning the photoactive layer including the materials in a desired region, its manufacture can be easily performed.

According to the present invention, a two-dimensional movement or a position of an optical signal and sense various signals can be sensed by using a change in intensity of the optical signal.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, the scope of the present invention should be understood within the scope of the present invention defined by the appended claims.

What is claimed is:

1. An apparatus for sensing optical signals, comprising:
a photoactive layer including an organic semiconductor material, the photoactive layer in which electrons and holes are produced by an incident light;
a first conductive pattern formed on one of upper and lower sides of the photoactive layer in a first direction parallel with the surface of the photoactive layer, the first conductive pattern to which the electrons produced in the photoactive layer are moved;
a second conductive pattern formed on the other of upper and lower sides of the photoactive layer in a second direction parallel with the surface of the photoactive layer, the second conductive pattern to which the holes produced in the photoactive layer are moved; and
an optical position detecting unit for detecting coordinate values of a point at which the incident light is incident onto the photoactive layer using the electrons and holes moved respectively to the first conductive pattern and the second conductive pattern.

2. The apparatus according to claim 1, wherein:
the first conductive pattern and the second conductive pattern include any one of indium tin oxide (ITO), carbon nano-tube (CNT), aluminum-doped zinc oxide (AZO) and zinc oxide (ZnO); and
the first conductive pattern and the second conductive pattern serve as transparent electrodes.

3. The apparatus according to claim 1, wherein:
the first conductive pattern includes ITO;
the second conductive pattern includes poly(3,4-ethylenedioxythiophene)poly(styrenesulfonate) (PEDOT:PSS); and
the first conductive pattern and the second conductive pattern serve as transparent electrodes.

4. The apparatus according to claim 1, wherein:
the first conductive pattern is an aluminum (Al) electrode; and
the second conductive pattern includes any one of ITO, CNT, AZO and ZnO, and serves as transparent electrodes.

5. The apparatus according to claim 1, wherein the optical position detecting unit comprises:
a converter for converting respectively positions at which currents flowing in the first direction and the second direction are generated into X coordinate value and Y coordinate value; and
a detector for detecting the X coordinate value and Y coordinate value.

6. The apparatus according to claim 1, wherein:
the photoactive layer senses a change in intensity of the incident light; and
the optical position detecting unit further comprises a converter for converting the change in intensity of the incident light into a Z coordinate value, and a detector for detecting the Z coordinate value.

7. The apparatus according to claim 1, wherein the first direction and the second direction are perpendicular to each other.

8. The apparatus according to claim 1, wherein the organic semiconductor material includes any one of poly(N-vinyl carbazole) (PVCz), 2,6-(4,4-bis(2-ethylhexyl)-4H-cyclopenta[2,1-b;3,4-b′]-dithiophene)-alt-4,7-(2,1,3-benzothiadiazole) (PCPDTBT), poly((2,7-(9,9-dioctyl)-fluorene)-alt-5,5-(4′,7′-di-2-thienyl-2′,1′,3′-benzothiadiazole) (PFDTBT), poly(5,7-di-2-thienyl-2,3-bis(3,5-di(2-ethylhexyloxy)phenyl)-thieno[3,4-b]pyrazine (PTBEHT), poly(3-hexylthiophene) (P3HT) and poly[2-methoxy-5(3′,7′-dimethyloctyloxy)-1,4-phenylene vinylene] (MDMO-PPV).

9. The apparatus according to claim 8, wherein:
the organic semiconductor material serves as a donor or an acceptor;
the donor includes any one of PCPDTBT, PFDTBT, PTBEHT, P3HT and MDMO-PPV; and
the acceptor includes any one of [6,6]-phenyl-C61-butyric acid methyl ester (PCBM), trinitrofluorenone (TNF) and TiOx.

10. The apparatus according to claim 1, further comprising:
an electron transfer layer formed between the photoactive layer and the first conductive pattern to help the electrons move; and
a hole transfer layer formed between the photoactive layer and the second conductive pattern to help the holes move,
wherein the electron transfer layer includes any one of TiOx and PCBM, and the hole transfer layer includes PEDOT:PSS.

11. An apparatus for sensing optical signals, comprising:
a photoactive layer including an organic semiconductor material, the photoactive layer in which electrons and holes are produced by an incident light;
a first conductive pattern formed on one of upper and lower sides of the photoactive layer in a first direction parallel with the surface of the photoactive layer, the first conductive pattern to which the electrons produced in the photoactive layer are moved;
a second conductive pattern formed on the other of upper and lower sides of the photoactive layer in a second direction parallel with the surface of the photoactive layer, the second conductive pattern to which the holes produced in the photoactive layer are moved; and
an optical position detecting unit for detecting coordinate values of a point at which the incident light is incident using the electrons and holes moved respectively to the first conductive pattern and the second conductive pattern,
wherein the photoactive layer are formed only at intersection areas of the first conductive pattern and the second conductive pattern.

12. A apparatus for remote-controlling using optical signals, comprising:
an optical signal generating unit for generating an optical signal through an operation of a user;
a display unit for receiving the optical signal and displaying an image or a menu selected by the optical signal and a content corresponding to the image or the menu;
an optical sensor unit for sensing the optical signal and detecting coordinate values of a position at which the optical signal is incident onto the display unit; and
a control unit for transmitting the image or the menu corresponding to the coordinate values and the content corresponding to the image and the menu to the display unit,
wherein the optical sensor unit is an apparatus according to claims 1 or 11.
